(19) United States
(12) Patent Application Publication
(10) Pub. No.: US 2009/0180028 A1
(43) Pub. Date: Jul. 16, 2009

(54) METHOD AND SYSTEM FOR 3-D COLOR ADJUSTMENT BASED ON COLOR REGION DEFINITION USING PWL MODULES

(76) Inventors: David Wu, San Diego, CA (US); Darren Neuman, Palo Alto, CA (US); Brian Schoner, Fremont, CA (US); Jaewon Shin, Santa Clara, CA (US)

Correspondence Address: MCANDREWS HELD & MALLOY, LTD, 500 WEST MADISON STREET, SUITE 3400, CHICAGO, IL, 60661, US

(21) Appl. No.: 12/354,268

(22) Filed: Jan. 15, 2009

Related U.S. Application Data
(60) Provisional application No. 61/021,273, filed on Jan. 15, 2008.

(51) Int. Cl. H04N 9/65

(52) U.S. Cl. 348/642; 348/E09.045

(57) ABSTRACT

A video processing system may be operable to utilize one-dimensional (1-D) piecewise linear (PWL) functions to adjust chroma and/or luma parameters corresponding to pixels that are determined to fall within one or more N-dimensional color adjustment regions in spatial representation of pixels' chroma and luma information. The chroma and/or luma parameters comprise Y, Cb, Cr, saturation and/or hue parameters in systems using Y′CbCr color coding. The 1-D PWL functions are operable to generate adjustment data corresponding to one of chroma and/or luma parameters, wherein the adjustment data comprise offset or gain data. The 1-D PWL functions are reprogrammable. The 1-D PWL functions may enable smooth transitions in boundary areas of at least some of the N-dimensional color adjustment regions. Determination of whether pixels fall within the color adjustment regions is based on a plurality of boundary points and/or criteria. Adjustment data corresponding to overlapped regions are aggregated.

### CROSS-REFERENCE TO RELATED APPLICATIONS/INCORPORATION BY REFERENCE

This patent application makes reference to, claims priority to and claims benefit from U.S. Provisional Application Ser. No. 61/021,273 (Attorney Docket No. 19287US01) filed on Jan. 15, 2008.

The above stated application is hereby incorporated herein by reference in its entirety.

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

Certain embodiments of the invention relate to video processing. More specifically, certain embodiments of the invention relate to a method and system for 3-D color adjustment based on color region definition using PWL modules.

### BACKGROUND OF THE INVENTION

In video systems, an image is projected in a display terminal such as televisions and/or PC monitors. Most video broadcasts, nowadays, utilize video processing applications that enable broadcasting video images in the form of bit streams that comprise information regarding characteristics of the image to be displayed including brightness (luma) and color (chroma). These video applications may utilize one or more of available encoding scheme including Y′CbCr, wherein the chroma data in each video pixel may be represented via the Cb-Cr value.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for 3-D color adjustment based on color region definition using PWL modules, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram that illustrates an exemplary video system that comprises a color management module that is operable to adjust luma and chroma signals based on color adjustment regions, in accordance with an embodiment of the invention.

FIG. 1B is a diagram that illustrates a Cb-Cr plane for chroma values of video pixels that may be utilized during color management operations, in accordance with an embodiment of the invention.

FIG. 1C is a diagram that illustrates use of angular color adjustment regions in a Cb-Cr plane to enable performing color adjustments of video pixels, in accordance with an embodiment of the invention.

FIG. 1D is a diagram that illustrates use of 1-dimensional (1D) piecewise linear (PWL) function to perform color adjustments of video pixels based on color adjustment regions, in accordance with an embodiment of the invention.

FIG. 2A is a block diagram that illustrates an exemplary color management module that is operable to perform PWL based color adjustment processing, in accordance with an embodiment of the invention.

FIG. 2B is a block diagram that illustrates an exemplary adjustment calculation block that utilized 1-D PWL arrays to perform color adjustment processing, in accordance with an embodiment of the invention.

FIG. 3 is a flow chart that illustrates use of 1-D PWL based color management operations, in accordance with an embodiment of the invention.

### DETAILED DESCRIPTION OF THE INVENTION

Certain embodiments of the invention may be found in a method and system for 3-D color adjustment based on color region definition using PWL modules. In various embodiments of the invention, a video processing system may be operable to utilize one-dimensional (1-D) piecewise linear (PWL) functions to adjust chroma and/or luma parameters corresponding to pixels that are determined to fall within one or more N-dimensional color adjustment regions in spatial representation of pixels' chroma and luma information. In instances where the video processing system may utilize Y′CbCr color coding, the chroma and/or luma parameters may comprise Y, Cb, Cr, saturation and/or hue parameters corresponding to pixels determined to fall within the color adjustment regions, which may comprise, for example, three-dimensional (3-D) color regions corresponding to Y/Cb/Cr or Y/saturation/hue data. The 1-D PWL functions may be utilized to generate adjustment data corresponding to one of chroma and/or luma parameters. The adjustment data generate by each 1-D PWL function may comprise offset or gain data. The adjustment performed via the 1-D PWL functions may be predetermined and/or determined dynamically based on user input. At least some of the 1-D PWL functions may be reprogrammable. Some of the 1-D PWL functions may be defined to enable smooth transitions in boundary areas of at least some of the color adjustment regions. Determination of whether pixels fall within the color adjustment regions may be performed by comparing the pixels' chroma and/or luma data to a plurality of boundary points and/or criteria that may be utilized to define the color adjustment regions within the spatial representation. In instances where pixels may be determined to fall within a plurality of overlapped color adjustment regions, adjustment data corresponding to the individual color adjustment regions may be aggregated to generate finalized chroma and/or luma adjustment data.

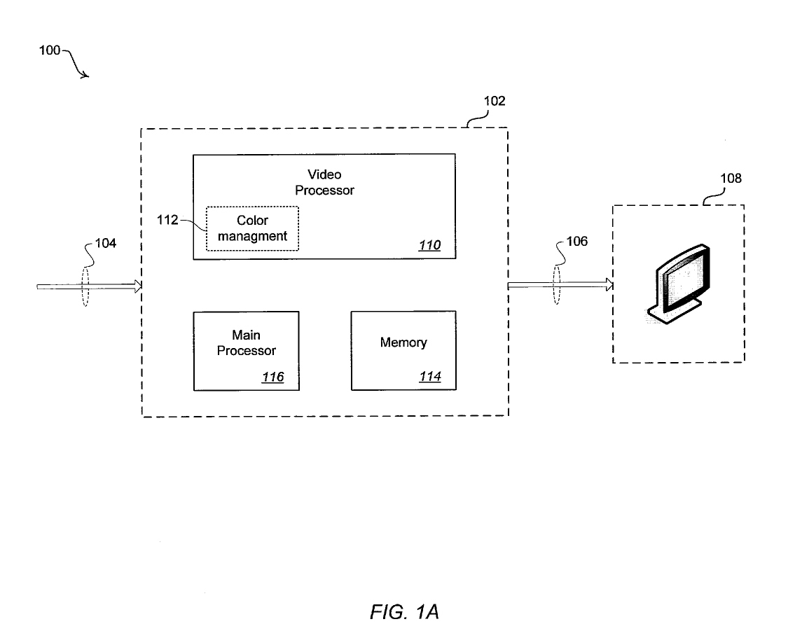

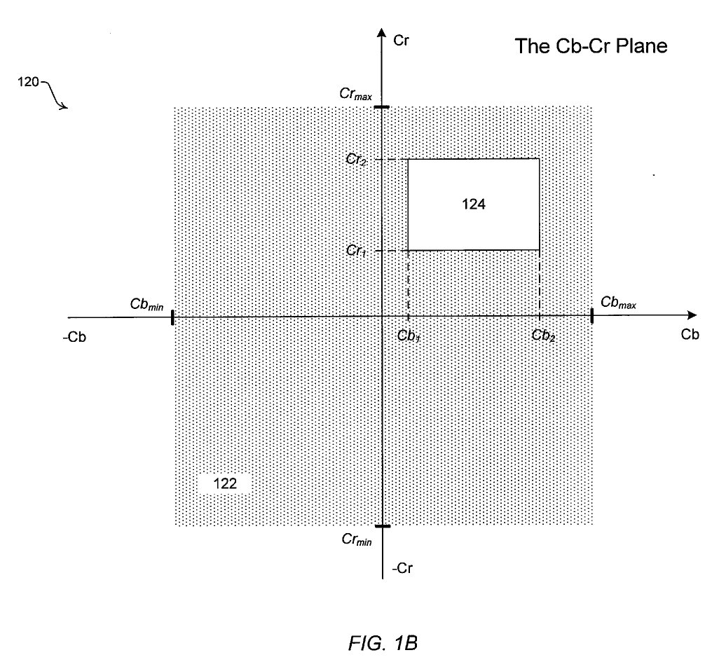

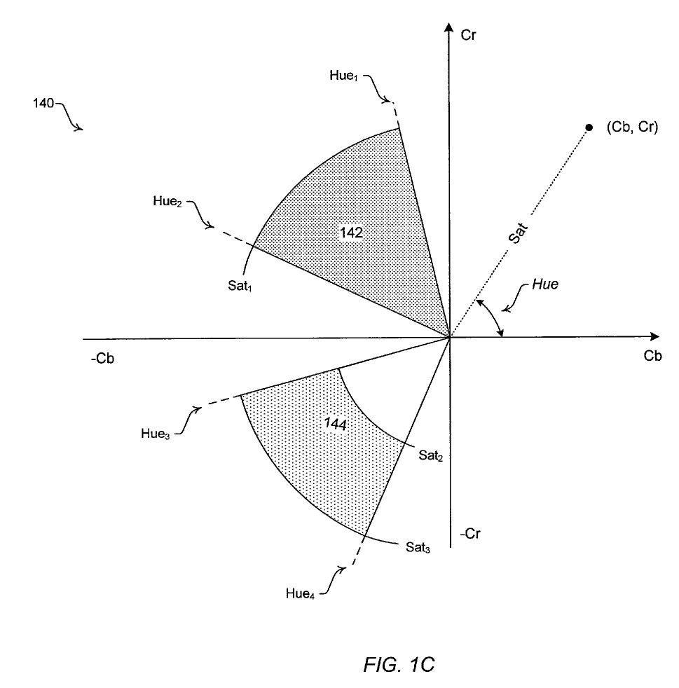

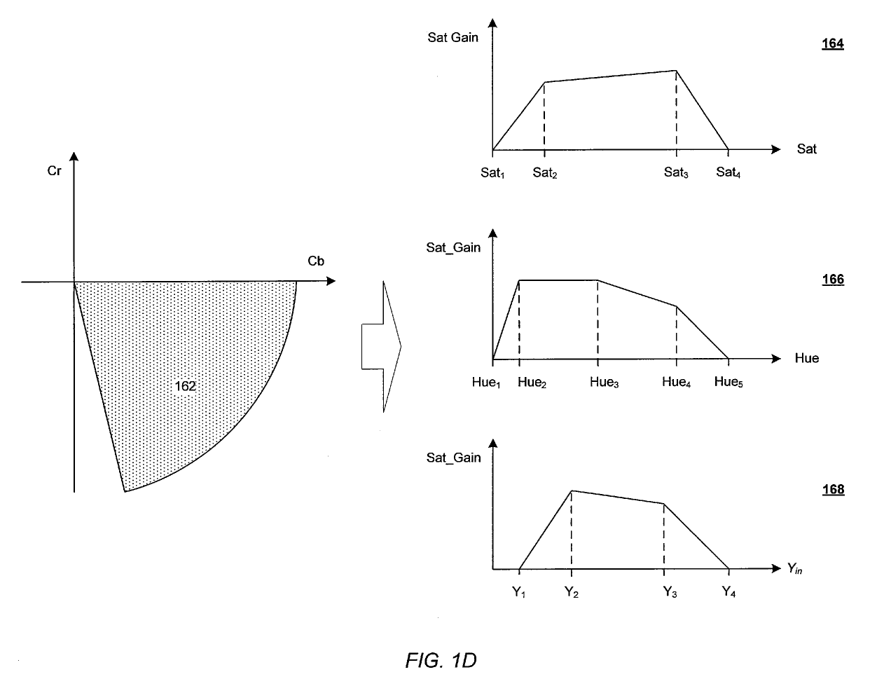

FIG. 1A is a block diagram that illustrates an exemplary video system that comprises a color management module that is operable to adjust luma and chroma signals based on color adjustment regions, in accordance with an embodiment of the invention. Referring to FIG. 1, there is shown a video system 100 comprising a processing subsystem 102, an input video stream 104, an output video stream 106, a display subsystem 108, a video processor 110, a color management module 112, a memory 114, and a main processor 116.

The processing subsystem 102 may comprise the video processor 110, the color management module 112, the memory 114, the main processor 116, and suitable logic, circuitry, interfaces and/or code that may enable processing of video streams and/or to generate video playback streams.

The video processor 110 may comprise suitable logic, circuitry, interfaces and/or code that may enable performing video processing operations, including, for example color management operations, which may be performed via the color management module 112. The video processor 110 may be operable to process the input video stream 104, received via the video system 100, to enable generating the output video stream 106 for display via the display subsystem 108. The color management module 112 may comprise suitable logic, circuitry, interfaces and/or code that may enable adjusting and/or improving color and/or brightness information corresponding to images extracted from the input video stream 104. The color management module 112 may be operable, for example, to facilitate 3-dimensional (3-D) color changes and/or improvements by adjusting luma and/or chroma parameters and/or signals.

The main processor 116 may comprise suitable logic, circuitry, interfaces and/or code that enable performing main control and/or management operations in the processing subsystem 102. The main processor 116 is utilized to control at least a portion of the memory 114, the video processor 110, and/or the color management module 112. In this regard, the main processor 116 may generate, for example, at least one or more signals for controlling operations within the processing subsystem 102. The main processor 116 may also enable execution of applications that may be utilized by the processing subsystem 102.

The memory 114 may comprise suitable logic, circuitry, interfaces and/or code that may enable storage and/or retrieval of data, code and/or instructions in the processing subsystem 102. The memory 114 may be operable, for example, to queue data and/or storage of code and/or configuration data utilized during video processing operations via the processing subsystem 102.

The display subsystem 108 may comprise suitable logic, circuitry, interfaces and/or code that may enable performing display operations based on the output video stream 106, generated via the processing subsystem 110. The display subsystem 108 and the processing subsystem 110 may be integrated within a single device, for example within a television. Alternatively, the display subsystem 108 and the processing subsystem 110 may be integrated in different devices that may then be coupled to enable playback operations. For example, the display subsystem 108 may correspond to display logic in a television whilst the processing subsystem 110 may be integrated within a set-top box that may be utilized to perform dedicated video processing operations.

The input video stream 104 may comprise a data stream comprising video information. The input video stream 104 may comprise, for example, an encoded video stream which may be generated and/or communicated, for example, via television head-ends and/or audio/video playback devices. The output video stream 106 may comprise a stream of video data is that suitable for display operations via display logic, for example in the display subsystem 108.

In operation, the video system 100 may be operable to perform video display and/or playback operations, to facilitate, for example, displaying of images corresponding to video data received via the input video stream 104. The processing subsystem 102 may be operable to perform video processing operations, via the video processor 110, which may enable, for example, generation of the output video stream 106, which may be utilized to facilitate video display and/or playback operations via the display subsystem 108. The video processor 110 may be operable, for example, to generate the luma and chroma signals pertaining to images that may correspond to video data received via the input video stream 104. Luma signals may represent the brightness information while the chroma signals may represent the color information. For the Y′CbCr color space, the Cr and Cb parameters may correspond to color or chroma component of images and the Y′ parameter may represent the brightness or luma component of the images. In the Y′CbCr color space, color may be represented as brightness and two color difference signals. Each image may be represented by a plurality of Y′CbCr encoded video pixels, each of which may be represented as a triplet (Y, Cb, Cr).

In accordance with various embodiments of the invention, the video system 100 may be operable to provide 3-D color improvement and/or enhancement of images displayed by the display subsystem 108. In this regard, the video processor 110 may be operable to adjust the chroma and/or luma parameters corresponding to at least some of pixels in images. For example, the color management module 112 may be operable to perform 3-D color adjustments, to enable improving color impressions of corresponding images. To facilitate 3-D color adjustments, the color management 112 may be operable to control, manage and/or adjust chroma and luma parameters during video processing operations. For example, in a system that utilizes Y′CbCr video encoding, the color management module 112 may be operable to adjust the luma by adjusting the Y component and to adjust the chroma by adjusting the Cb and/or Cr components of image pixels. For example, offset and/or gain adjustments to each of the Y, Cb and/or Cr components of video pixels may be utilized to perform 3-D color adjustment. In this regard, offset adjustment may refer to additive adjustment wherein a parameter may be adjusted by adding or subtracting a specified and/or determined offset. Gain adjustment may refer to scaling adjustment wherein a parameter may be adjusted by apply, via multiplication procedure, a specified and/or determined scaling factor. Thus, the output Y, Cb, and/or Cr values may be expressed as:

Yₒᵤₜ=Yᵢₙ*Y_gain+Y_offset

Cbₒᵤₜ=Cbᵢₙ*Cb_gain+Cb_offset

Crₒᵤₜ=Crᵢₙ*Cr_gain+Cr_offset

The 3-D color adjustments may be performed based on determination of color adjustment regions. For example, the color management module 112 may be operable to determine whether pixels may fall into one or more color adjustment regions, which may be predefined and/or dynamically specified. Exemplary color adjustment regions may comprise pixels that may be determined to correspond to specific criteria which may be deemed to require special treatment, for example flesh tones, grass green and/or sky blue shades. The color adjustment regions may be defined, for example, utilizing chroma and/or luma parameters based on supported coloring schemes. For example, were Y′CbCr video encoding may be utilized, color adjustment regions may be defined by specifying boundary points and/or criteria in spatial representation of valid (Cb, Cr) pairs and/or (Y, Cb, Cr) triplets.

In an exemplary embodiment of the invention, the color management module 112 may be operable to utilize 1-dimensional (1-D) piecewise linear (PWL) functions to facilitate adjusting chroma and/or luma parameters during video operations in the video processor 110. Linear functions are first-order polynomial functions that generate output values from input values using first-degree scaling and shifting operations, for example in the form of:

y=a*x+b

where y is output value, x is input value, and both ‘a’ and ‘b’ are constants. Piecewise linear functions enable generating output values linearly from input values using a plurality of different sets of linear parameters each applicable to a specified range of input values. For example, a one-dimensional (1-D) piecewise linear (PWL) may be defined as a plurality of pairs {(x0,y0), (x1,y1), . . . (xN,yN)}, where y=y(i−1)+slope*(x−x(i−1), wherein slope=(y(i)−y(i−1))/(x(i)−x(i−1)). The 1-D PWL functions may be operable to enable, for example, adjusting each of applicable chroma and/or luma parameters, separately, in piecewise linear manner. In a system that utilizes Y′CbCr encoding, for example, a plurality of 1-D PWL functions may be utilized to enable determining and/or applying offset or gain adjustments to each of the Y, Cb and/or Cr components of video pixels, wherein up to 3 1-D PWL functions, for example, may be utilized to generate a single adjustment output. In this regard, Offset adjustments may refer to additive adjustments wherein a parameter may be adjusted by adding or subtracting a specified offset. Gain adjustments may refer to scaling adjustments wherein a parameter may be adjusted by apply, via multiplication procedure, a specified scaling factor. The 3-D color adjustment may then be effectuated by combining the effects of all individual 1-D adjustments.

FIG. 1B is a diagram that illustrates a Cb-Cr plane for chroma values of video pixels that may be utilized during color management operations, in accordance with an embodiment of the invention. Referring to FIG. 1B, there is shown a Cb-Cr plane 120, a 2-dimensional plane, representing color information based on Y′CbCr video encoding scheme, which may be utilized in video processing systems, for example the video system 100, during video processing operations. The shaded region 102 may represent a valid Cb-Cr region in the Cb-Cr plane 120.

In the Y′CbCr color space, the Cr and Cb may correspond to color, or chroma, component of a digital image while Y′ may represent the brightness, or luma, component of a digital image. In Y′CbCr color space systems may represents color as brightness and two color difference signals wherein Y′ is the brightness, Cb is blue minus luma (B−Y) and Cr is red minus luma (R−Y). The Y′CbCr encoded video pixels may be represented as triplets (Y, Cb, Cr). In a system that utilizes n-bit encoding, the Y′ may vary in value from 0 to [2ⁿ−1], with Y′=0 representing minimum brightness (black), and Y′=[2ⁿ−1] representing maximum brightness (white); the value of Cb may vary between [−2ⁿ⁻¹] and [2ⁿ⁻¹−1], with Cb=[−2ⁿ⁻¹] representing minimum blue difference, and Cb=[2ⁿ⁻¹−1] representing maximum blue-difference; and the value of Cr may vary between [−2ⁿ⁻¹] and [2ⁿ⁻¹−1], with Cr=[−2ⁿ⁻¹] representing minimum red-difference, and Cr=[2ⁿ⁻¹−1] representing maximum red-difference. For example, in an 8-bit encoding scheme, an Y′CbCr triplet may be represented as (127, 0, 127), wherein the Y′ may have a value of 127, a Cb may have a value of 0, and the Cr may have a value of 127.

The Cb-Cr plane 120 may be utilized to provide spatial representation of available and/or valid color pixels in a system that utilizes Y′CbCr video encoding scheme during video processing operations. The Cb-axis may represent Cb (blueness) values, and the Cr-axis may represent Cr (redness) values. The shaded region 102 may represent a valid Cb-Cr region in the Cb-Cr plane 120. While the Cb-Cr plane 120, and each of the Cb-axis and/or the Cr-axis may extend indefinitely, only a limited region within the Cb-Cr plane may correspond to valid (Cb, Cr) pairs, which may be based on encoding parameters in the system, wherein a valid Cb value may be between Cbₘᵢₙ and Cbₘₐₓ, and a valid Cr value may be between Crₘᵢₙ and Crₘₐₓ. For example, in a system that utilizes an 8-bit encoding of Y′CbCr color space, the value of Cb may vary Cbₘᵢₙ=−128 and Cbₘₐₓ=127, and the value of Cr may vary Crₘᵢₙ=−128 and Crₘₐₓ=127; and the valid region 102 may be delineated by the pairs (127, 127), (127, −128), (−128, 127), and (−128, −128).

In operations, the Cb-Cr plane 120 may be utilized to enable performing color management operations, for example via the color management module 112 in the video processor 110. The color adjustments may be performed, for example, based on determination of color adjustment regions, wherein only pixels that may fall within defined color adjustment regions may be adjusted. For example, the color management module 112 may be operable to utilize the spatial color representation based on the Cb-Cr plane 120 to define rectangular color adjustment regions, wherein each color adjustment region may be defined by specifying, for example, four (Cb, Cr) pairs. The color management module 112 may define, for example, the color adjustment region 124, which may be defined by specifying the boundary pairs: (Cb₁, Cr₁), (Cb₂, Cr₁), (Cb₁, Cr₂), and (Cb₂, Cr₂). The four pairs may enable determining when pixels fall within the color adjustment region 124 by comparing pixels' Cb and Cr coordinates with Cb₁, Cb₂, Cr₁, and Cr₂. For example, only pixels whose Cbᵢ and Crᵢ values are such that Cb₁<Cbᵢ<Cb₂ and Cr₁<Crᵢ<Cr₂ are determined to fall within color adjustment region 124.

Luma information, represented, for example, by pixels Y components may enable providing a third dimension, perpendicular to the Cb-Cr plane 120, to facilitate 3-D color adjustments. For example, once pixels are determined to be within the color adjustment region 124, 3-D color adjustments may be performing by applying gain and/or offset adjustment to the Y component in addition to any adjustments to the Cb, and/or Cr components. The adjustments may be applied separately, and may then be combined to create the 3-D color adjustment effect. For example, offset and gain adjustments may be applied separately to each of the Y, Cb, and Cr component, for a total of 6 adjustments, which may then be combined to generate a total chroma/luma change that may correspond to the desired 3-D color adjustment. In an exemplary aspect of the invention, 1-D PWL functions may be utilized, via the color management module 112 for example, to define applicable offset and/or gain adjustments that may be applied, for example, to Y, Cr, and/or Cb parameters of pixels that are within the color adjustment region 124.

FIG. 1C is a diagram that illustrates use of angular color adjustment regions in a Cb-Cr plane to enable performing color adjustments of video pixels, in accordance with an embodiment of the invention. Referring to FIG. 1C, there is shown a Cb-Cr plane 140 which is substantially similar to the Cb-Cr plane 120 as described in FIG. 1B, and may be similarly applicable to enable performing color adjustments, via the color management module 112 in the video processor 110, for example.

However, angular representation, which may be based on use of saturation and hue, may be utilized for pixels instead of using rectangular coordinates based representation during color management and/or adjustment operations with regards to the Cb-Cr space 140. For example, for each pixel which may be represented by a (Cb, Cr) pair in the Cb-Cr plane 140, saturation (Sat) and angle (Hue) information may be determined and/or utilized, rather than using pixels' Cb/Cr coordinates, to identify the pixel within the chroma spatial representation in the Cb-Cr plane 140. Pixels' Sat and Hue parameters may be calculated from the pixels' Cb/Cr parameters, via Cb/Cr-Sat/Hue conversions, which may be performed as:

Sat=\sqrt{Cb²+Cr²}

Hue=tan⁻¹(Cr/Cb)

In operations, the Cb-Cr plane 140 may be utilized to enable performing color management and/or adjustment operations, for example via the color management module 112 in the video processor 110, based on pixel angular representation. Color adjustment region definition and/or chroma/luma parameter adjustments may be performed based on, for example, saturation/hue information. Chroma adjustment may be performed, for example, by utilizing offset and/or gain adjustment of saturation and/or hue parameters rather than Cr and Cb parameters. Color adjustment region determination may be performed based on use of angular region representation. For example, the color management module 112 may be operable to utilize the spatial color representation based on the Cb-Cr plane 140 to define angular color adjustment regions. The color management module 112 may define, for example, a color adjustment region 142 by defining a maximum saturation Sat₁ and delineating angles Hue₁ and Hue₂. Pixels whose saturation and hue parameters Sat and Hue, which may be determined based on Cb/Cr-Sat/Hue conversions, may fall within the color adjustment region 142 when Hue₁<Hue<Hue₂ and Sat<Sat₁.

The angular color adjustment region definition may further comprise specifying a minimum saturation, to enable defining sectored angular regions for example. The color management module 112 may define, for example, the color adjustment region 144 by defining a minimum saturation Sat₂, a maximum saturation Sat₃, and delineating angles Hue₃ and Hue₄. Accordingly, pixels whose saturation and hue parameters are determined to be Sat and Hue may fall within the color adjustment region 144 when Hue₃<Hue<Hue₄ and Sat₂<Sat<Sat₃.

Luma information, represented by pixels' Y components for example, may similarly enable providing a third dimension, perpendicular to the Cb-Cr plane 140, to facilitate 3-D color adjustments, substantially as described with regards to FIG. 1B. Accordingly, 3-D color adjustments may be performing by applying gain and/or offset adjustment to the Y component in addition to any adjustments to the Sat, and/or Hue components, wherein 1-D PWL functions may be utilized, via the color management module 112 for example, to define applicable offset and/or gain adjustments that may be applied to each of the chroma/luma parameters of pixels that are within the color adjustment regions 142 and/or 144. For example, up to 3 1-D PWL functions may be utilized to generate a single offset or gain adjustment output that may be applied to one of chroma and/or luma parameters. The offset and/or gain adjustment may be defined within the 1-D PWL functions based on angular representation, Y/Sat/Hue, and/or based on rectangular representation Y/Cb/Cr. Where Y/Sat/Hue based adjustments are performed, the adjusted Y/Sat/Hue data may then be converted to Y/Cb/Cr data, utilizing Cb/Cr-Sat/Hue conversions to enable, for example, generating Y′CbCr based output information.

FIG. 1D is a diagram that illustrates use of 1-dimensional (1D) piecewise linear (PWL) function to perform color adjustments of video pixels based on color adjustment regions, in accordance with an embodiment of the invention. Referring to FIG. 1D, there is shown an angular color adjustment region 162 in a Cb-Cr plane, for example the Cb-Cr 140, which may comprise a plurality of pixels whose chroma and/or luma may be adjusted via 3-D color management and/or adjustment operations, via the color management module 112 for example, utilizing one-dimensional (1-D) piecewise linear (PWL) functions.

In operations, chroma/luma adjustments of pixels in the color adjustment region 162 may be performed utilizing 1-D PWL functions that enable performing separate offset and/or gain adjustments of each of applicable chroma and/or luma parameters. In a system that may utilize Y′CbCr color scheme, for example, a plurality of 1-D PWL functions may be utilized wherein each 1-D PWL function enables generating Cb, Cr, Y, saturation or hue gain or offset adjustment data based on a single input, which may be one of pixels' saturation, hue, Cb, Cr, or Y. For example, during saturation gain adjustment in the color adjustment region 162, saturation gain 1-D PWL functions 164, 166 and 168, which may be defined based on use of pixels' angular representation, Sat/Hue/Y, may be utilized to determine individual saturation gain factors, based on each of the three parameters Sat/Hue/Y, to facilitate generating a final saturation gain adjustment. The 1-D PWL function 164 may specify, for example, three different linear pieces delineated by four threshold values Sat₁, Sat₂, Sat₃, and Sat₄, to enable generating a saturation gain factor based on input Sat. The 1-D PWL function 166 may specify four different linear pieces, delineated by five threshold values Hue₁, Hue₂, Hue₃, Hue₄, and Hue₅, to enable generating a saturation gain factor based on input Hue. The 1-D PWL function 168 may specify, for example, three different linear pieces delineated by four threshold values Y₁, Y₂, Y₃, and Y₄, to enable generating a saturation gain factor based on input Y. Consequently, when determining saturation gain adjustment for a pixel that is determined to be within the color adjustment region 162, the 1-D PWL functions 164, 166 and 168 may be utilized to generate three saturation gain factors based on the pixel's Sat/Hue/Y parameters. In that regards, the pixels' Sat, Hue and Y parameters are applied as inputs into the 1-D PWL functions 164, 166 and 168, wherein the appropriate output factor is generated based on comparison of the pixel's Sat, Hue and Y parameters with the threshold values for each of the 1-D PWL functions.

The final adjustments may be derived by combining all corresponding 1-D PWL outputs. The final adjustment may be computed as a product of a peak_gain, a scaling parameter that may be predetermined and/or programmable, and a normalized gain factor, which may be set to the product or the minimum absolute of corresponding 1-D PWL outputs. For example, the final saturation gain adjustment in the color adjustment region 162 may be calculated as:

Adj=Peak_gain*PWL_gain0(Sat)*PWL_gain1(Hue)*PWL_gain2(Y)

where PWL_gain0 is the output of 1-D PWL function 164, PWL_gain1 is the output of 1-D PWL function 166, PWL_gain2 is the output of 1-D PWL function 168. In an exemplary embodiment of the invention, 1-D PWL functions utilized to perform offset and/or gain adjustments may be programmed to generate normalized gain which may take values between {−1, 1}. The peak_gain may be a preset parameter that may be utilized to scale the normalized adjustment factors of the 1-D PWL functions 164, 166 and 168. Different peak_gain values may specified for each type of adjustment. For example, the peak_gain for offset adjustments may be set to value between 0 and 256 in 8-bits color encoding system while peak_gain for gain adjustments may set to a value between 0 and 2.0 (0-200%). The 1-D PWL functions may be programmed to ensure smooth boundary transitions close to edges of color adjustment regions, to guard against undesired and/or abrupt color changes for example. The linear pieces corresponding to input parameters values near the minimum and maximum input values may be programmed to provide small gain and/or offset adjustments, for example. In an exemplary embodiment of the invention, special region boundary definitions, which may be programmable, may be utilized to enable determining when pixels fall within special boundary sub-regions. Color processing of such pixels may then be adjusted, by applying additional predetermined scaling gains for example, to achieve smooth boundary transitions.

In instances where multiple color adjustment regions may overlap, at least some pixels may be found to fall within one or more regions. Accordingly, individual region adjustments maybe aggregated to determine final adjustments. For example, where a pixel is determine to fall within multiple regions, each region adjustments may be computed in parallel as Sat_gain(i), Sat_off(i), Hue_off(i), Cr_off(i), Cb_off(i), Y_off(i), and/or Y_gain(i). The overall adjustments may then be aggregated, where there may be ‘I’ overlapped regions, as:

$$Sat\_gain = {\prod }_{i = 1}^{I} Sat\_gain ( i )$$

$$Sat\_off = {\sum }_{i = 1}^{I} Sat\_off ( i )$$

$$Hue\_off = {\sum }_{i = 1}^{I} Hue\_off ( i )$$

$$Cb\_off = {\sum }_{i = 1}^{I} Cb\_off ( i )$$

$$Cr\_off = {\sum }_{i = 1}^{I} Cr\_off ( i )$$

$$Y\_off = {\sum }_{i = 1}^{I} Y\_off ( i )$$

$$Y\_gain = {\prod }_{i = 1}^{I} Y\_gain ( i )$$

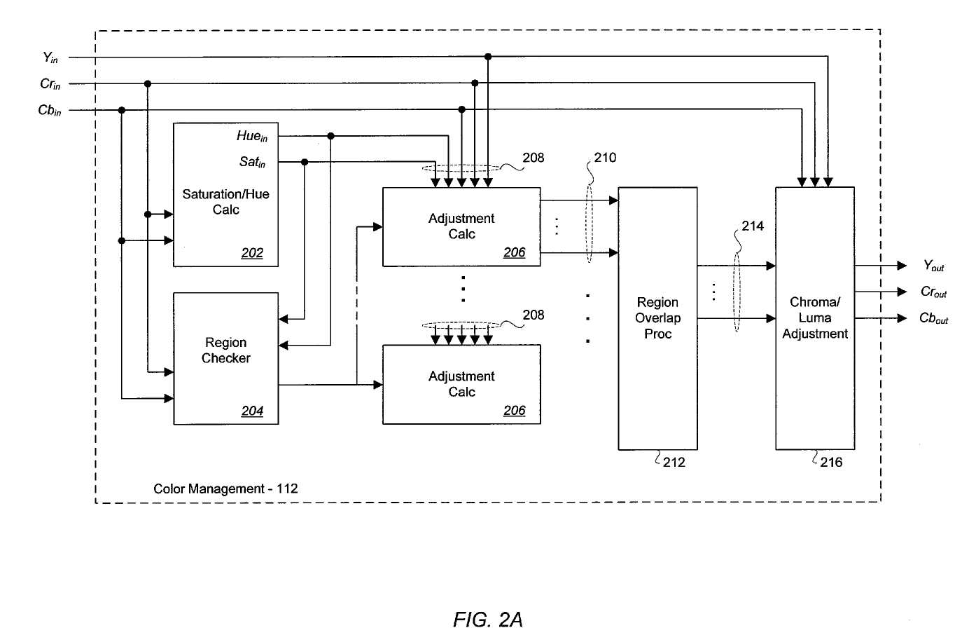

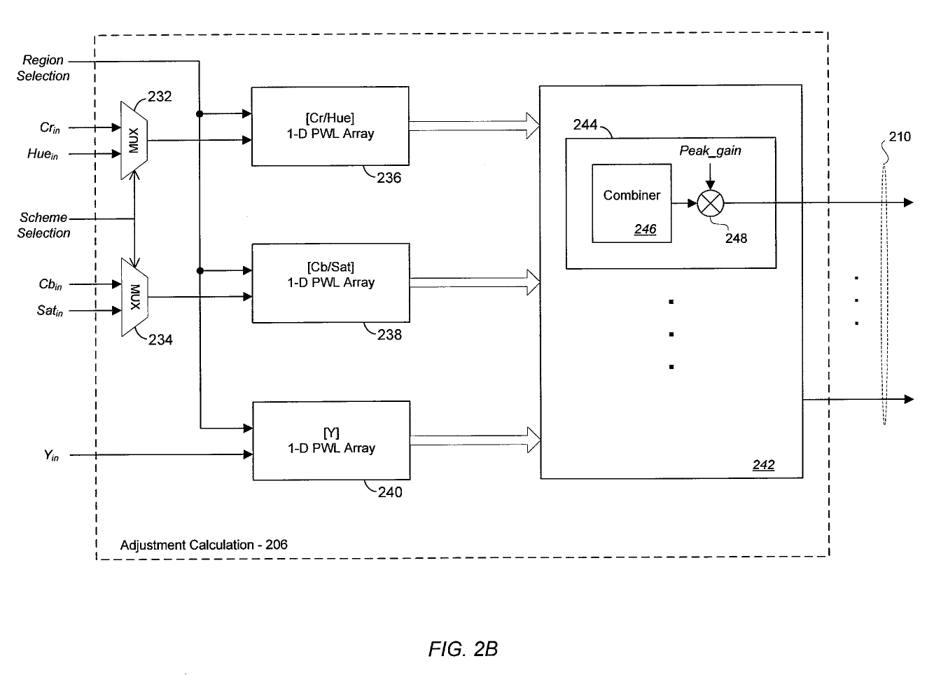

FIG. 2A is a block diagram that illustrates an exemplary color management module that is operable to perform PWL based color adjustment processing, in accordance with an embodiment of the invention. Referring to FIG. 2A, there is shown the color management module 112, a saturation/hue calculation functions 202, a region checker 204, a plurality of adjustment calculation function 206, a region overlap processing function 212, and a chroma/luma adjustment function 216.

The saturation/hue calculation function 202 may comprise suitable logic, circuitry and/or code that may enable performing determining saturation and/or hue information for pixels processed via the color management module 112. The saturation/hue calculation function 202 may be operable, for example, to utilize Cb/Cr-Sat/Hue conversions, substantially as described with regard to FIG. 1A, to generate saturation and hue parameters, Satᵢₙ and Hueᵢₙ from Cbᵢₙ and Crᵢₙ corresponding to processed pixels.

The region checker 204 may comprise suitable logic, circuitry and/or code that may enable determining color adjustment regions where processed pixels may fall. For example, the region checker 204 may be operable to compare processed pixels Cb/Cr and Sat/Hue parameters to boundary points and/or criteria to determine whether the processed pixels are within defined color adjustment regions. The region checker 204 may then be operable to generate control signals to enable performing color adjustment based on matched regions.

Each adjustment calculation functions 206 may comprise suitable logic, circuitry and/or code that may enable performing color adjustments of processed pixels' input parameters, based on specified and/or determined adjustment criteria and/or parameters corresponding to a matched color adjustment region.

The region overlap processing function 212 may comprise suitable logic, circuitry and/or code that may enable performing region overlap processing operations, substantially as described with regards to FIG. 1D, to finalize and/or modify chroma and/or luma parameter adjustments where processed pixels are determined to match more than one color adjustment region.

The chroma/luma adjustment function 216 may comprise suitable logic, circuitry and/or code that may be operable to generate and/or modify chroma and/or luma information corresponding to processed pixels based on final chroma and/or luma parameter adjustments.

In operation, the color management module 112 may be utilized, in the video processor 110, to perform color adjustments during processing of video streams. For example, during processing of the input video stream 104, the color management module 112 may be operable to process chroma and/or luma parameters corresponding to at least some of processed pixels corresponding to images data in the input video stream 104. In instances where the video processor 110 may be operable, for example, to utilize the Y′CbCr color scheme, the chroma/luma parameters may comprise Yᵢₙ, Cbᵢₙ and/or Crᵢₙ. The Yᵢₙ/Cbᵢₙ/Crᵢₙ data may be inputted into the saturation/hue calculation function 202 to enable generating corresponding Satᵢₙ/Hueᵢₙ. The Yᵢₙ/Cbᵢₙ/Crᵢₙ data may also be inputted into the region checker 204 to determine whether processed pixels match any of predefined and/or dynamically specified color adjustment regions. The region checker 204 may be operable to generate control signals to enable performing color adjustment based on matched regions, by enabling processing via a corresponding adjustment calculation function 206. Each adjustment calculation function 206 may receive a plurality of input data 208 which may comprise, for example, Yᵢₙ, Cbᵢₙ, Crᵢₙ, Satᵢₙ, and/or Hueᵢₙ data. The adjustment calculation function 206 may be operable to generate plurality of parameter adjustments 210 to facilitate 3-D color enhancement and/or improvement based on adjustment criteria in a specified and/or determined color adjustment region. The plurality of parameter adjustments 210 may comprise, for example, Cr, Cb, Y, Sat, Hue offset and/or gain adjustments. Where more than color adjustment region is matched, all instances of the plurality of parameter adjustments 210 may be processed via the region overlap processing function 212, substantially as described with regards to FIG. 1D, to enable aggregating respective parameter adjustments, to generate a finalized plurality of parameter adjustments 214. The plurality of parameter adjustments 214 may then be inputted into the chroma/luma adjustment function 216 to enable generating output chroma/luma data, Yₒᵤₜ/Cbₒᵤₜ/Crₒᵤₜ data, with the finalized parameters adjustments.

FIG. 2B is a block diagram that illustrates an exemplary adjustment calculation function that utilized 1-D PWL arrays to perform color adjustment processing, in accordance with an embodiment of the invention. Referring to FIG. 2A, there is show the adjustment calculation function 206, multiplexers (Muxes) 232 and 234, a Cr/Hue 1-D PWL array 236, a Cb/Sat 1-D PWL array 238, and a Y 1-D PWL array 240, a combining function 242, an adjustment combining element 244, a combining logic 246, and a multiplier 248.

Each of Muxes 232 and 234 may comprise suitable logic, circuitry and/or code that may enable selecting an output from a plurality of inputs, based on selection control signal. For example, Mux 232 may be operable to select between Hueᵢₙ and Crᵢₙ based on the scheme selection signal. The Mux 234 may similarly be operable to select between Satᵢₙ and Cbᵢₙ based on the scheme selection signal.

The Cr/Hue 1-D PWL array 236 may comprise suitable logic, circuitry and/or code that may enable generating offset and/or gain adjustment data based on Cr and/or Hue input values utilizing 1-dimensional (1-D) piecewise linear (PWL) functions. The Cr/Hue 1-D PWL array 236 may comprise a plurality of 1-D PWL modules, each of which may be operable to implement a single 1-D PWL function, substantially as described with regards to FIG. 1D, which may enable generating either chroma or luma based parameter gain or offset data. The Cb/Sat 1-D PWL array 238 and/or the Y 1-D PWL array 240 may be similar to the Cr/Hue 1-D PWL array 236, and maybe operable to generate offset and/or gain adjustment data based on Cb/Sat and Y input data, respectively. Where Y/Sat/Hue based adjustments are performed, the adjusted Y/Sat/Hue data may then be converted to Y/Cb/Cr data, utilizing Cb/Cr-Sat/Hue conversions to enable, for example, generating Y′CbCr based output information.

The combining function 242 may comprise a plurality of adjustment combining element 244, and may be operable to combine adjustment data generated via the Cr/Hue 1-D PWL array 236, the Cb/Sat 1-D PWL array 238 and/or the Y 1-D PWL array 240. The adjustment combining element 244 may comprise suitable logic, circuitry and/or code that may enable combining outputs of all 1-D PWL functions that generate adjustment data corresponding to a specific chroma or luma parameter. The adjustment combining element 244 may comprise combing logic 246 and a multiplier 248. The combing logic 246 may comprise suitable logic, circuitry and/or code that may enable generating a normalized factor output based on plurality of 1-D PWL function outputs. The multiplier 248 may comprise suitable logic, circuitry, interfaces and/or code that may enable multiplying an input by a gain value to generate a scaled output.

In operation, the adjustment calculation function 206 may be utilized, via the color management module 112 for example, to generate chroma and/or luma parameter adjustment data, for example, the plurality of parameter adjustments 210, pertaining to a color adjustment region. The Mux 232 and 234 may be operable to select between Crᵢₙ/Cbᵢₙ and Satᵢₙ/Hueᵢₙ data, based on the scheme selection signal, for example, to facilitate applying Sat/Hue/Y or Cb/Cr/Y representation based adjustments. The Yin input and the outputs of the Mux 232 and 234 may be inputted into the Cr/Hue 1-D PWL array 236, the Cb/Sat 1-D PWL array 238 and/or the Y 1-D PWL array 240. The region selection signal may enable applying 1-D PWL functions to generate adjustment data based on the Yᵢₙ/Cbᵢₙ/Crᵢₙ/Satᵢₙ/Hueᵢₙ data. For example, the Cr/Hue 1-D PWL array 236 may comprise a plurality of 1-D PWL modules, each of which may enable generating offset or gain adjustment data for one or chroma/luma parameters based on Cr or hue input. The adjustment data generated via the may be then inputted into the combining function 242 to enabling combining the adjustment data generated. The combining function 242 may be operable to combine and/or modify adjustment data pertaining to offset or gain adjustment for each chroma/luma parameter. For example, the adjustment combining element 244 may enable generating a normalized gain/offset factor based on all gain/offset factors generating via corresponding 1-D PWL functions, via the combining logic 246. The combing logic 246 may set the normalized factor output to the product or the minimum absolute of corresponding 1-D PWL outputs. The adjustment combining element 244 may then enable applying of a peak_gain, a scaling gain that be predetermined and/or programmable, via the multiplier 248.

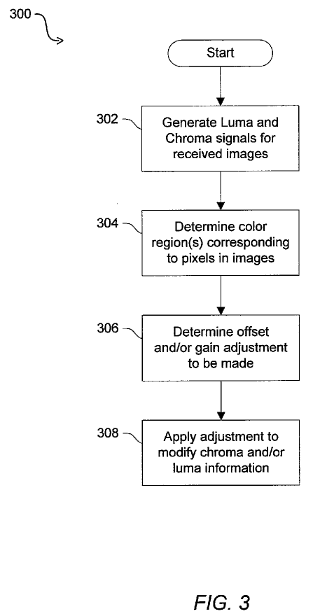

FIG. 3 is a flow chart that illustrates use of 1-D PWL based color management operations, in accordance with an embodiment of the invention. Referring to FIG. 3, there is shown a flow chart 300 comprising a plurality of exemplary steps, which may enable performing 3-D color adjustment utilizing 1-D PWL functions.

In step 302, luma and chroma signals may be generated. For example, the video processor 110 may be operable to generate luma and chroma information based on Y′CbCr data extracted from and/or generated based on received the input video stream 104. In step 304, a determination of color adjustment regions that corresponds to pixels corresponding to the generated luma and chroma information may be performed. For example, the (Cb, Cr) pairs, (Y′, Cb, Cr), and or the (Sat, Hue) pairs corresponding to extracted pixels may be utilized to determine whether the pixels fall within on or more of color adjustment regions that may be defined, via the color management module 112 for example. During color adjustment region determination, Cb/Cr-Sat/Hue conversions may be perform, if necessary, to enable accommodating rectangular or angular regions definitions. In exemplary aspect of the invention, pixels may fall within a plurality of color adjustment regions.

In step 306, offset and/or gain adjustments for each of applicable parameters may be performed. For example, the adjustment calculation functions 206a, . . . , 206b may be operable, in the color management module 112, to generate offset and/or gain adjustments, separately, for each of input Y, Cb, Cr, Hue, and/or Sat values provided, to generate the plurality of parameter adjustments 210. The parameter adjustments may be generated, utilizing a plurality of 1-D PWL functions, by the Cr/Hue 1-D PWL array 236, the Cb/Sat 1-D PWL array 238, and the Y 1-D PWL array 240 within each adjustment calculation function 206 for example.

In step 308, the parameter adjustments may be applied to modify the chroma and luma information. For example, the offset and/or gain adjustments may be combined and utilized during generation and/or adjustment of chroma/luma information corresponding to the output video stream 106 in the video system 100, via the chroma/luma adjustment function 216 in the color management module 112 in the video processor 110 for example. Additionally, in instances where pixels may fall within overlapping color adjustment regions, the parameters adjustments, as generated based on each applicable region, may first be aggregated, via the region overlap processing function 210 to aggregate for example, before performing the final chroma/luma adjustments.

Various embodiments of the invention may comprise a method and system for 3-D color adjustment based on color region definition using PWL modules. The color management module 112, in the video processor 110, may be operable to adjust chroma and/or luma information corresponding to pixels that may be determined to fall within one or more color adjustment regions in spatial representation of pixels' chroma and luma information, for example in the Cb-Cr planes 120 and/or 140, during video processing operations in the video system 100. The color management module 112 may be operable to utilize one-dimensional (1-D) piecewise linear (PWL) functions to perform the chroma and/or luma information. The chroma and/or luma parameters may comprise Y, Cb, Cr, saturation and/or hue parameters. The chroma and/or luma adjustments corresponding to matched color adjustment region may be generated via a plurality of the adjustment calculation function 206, wherein the Cr/Hue 1-D PWL array 236, the Cb/Sat 1-D PWL array 238 and/or the Y 1-D PWL array 240 may be utilized a plurality of 1-D PWL functions, each of which generate adjustment data corresponding to one of chroma and/or luma parameters.

The adjustment data generated by each of the 1-D PWL functions may comprise offset or gain data. For example, where 3-D color adjustment regions may be utilized, up to 3 1-D PWL functions may be used to generate a single offset or gain adjustment output that may be applied to one of chroma and/or luma parameters. The adjustment performed via the 1-D PWL functions may be predetermined and/or determined dynamically based on user input. At least some of the 1-D PWL functions in the Cr/Hue 1-D PWL array 236, the Cb/Sat 1-D PWL array 238 and/or the Y 1-D PWL array 240 may be reprogrammable. Some of the 1-D PWL functions may be defined to enable smooth transitions in boundary areas of at least some of the color adjustment regions. A determination of whether pixels fall within the color adjustment regions may be performed, via the region checker 204, by comparing the pixels' chroma and/or luma data to plurality of boundary points and/or criteria that may be utilized to define the color adjustment regions within the spatial representation. In instances where pixels may be determined to fall within a plurality of overlapped color adjustment regions, adjustment data corresponding to the individual color adjustment regions may be aggregated, via the region overlap processing function 212, to generate finalized chroma and/or luma adjustment data via the chroma/luma adjustment function 216.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for 3-D color adjustment based on color region definition using PWL modules.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for video processing, the method comprising:
determining one or more N-dimensional color adjustment regions within a spatial representation of chroma and luma information corresponding to pixels for an image, where N is an integer that is greater than 1; and; and
for said one or more determined N-dimensional color adjustment regions, adjusting said chroma and/or luma information for said pixels utilizing a plurality of one-dimensional (1-D) piece-wise linear (PWL) functions.

2. The method according to claim 1, wherein said chroma and/or luma information is based on Y′CbCr and/or Y/saturation/hue color space.

3. The method according to claim 2, wherein said luma and chroma information comprise Y, Cb, Cr, Hue, and/or Saturation parameters of said pixels.

4. The method according to claim 1, wherein each of said plurality of 1-D PWL functions is utilized to adjust only one of chroma or luma parameters corresponding to said pixels.

5. The method according to claim 4, wherein each of said plurality of 1-D PWL functions is utilized to generate gain or offset adjustment data based on said chroma and/or luma information.

6. The method according to claim 4, wherein at least some of said plurality of 1-D PWL functions is reprogrammable.

7. The method according to claim 4, wherein said plurality of 1-D PWL functions is utilized to enable smooth transitions at boundary areas of at least some of said color adjustment regions.

8. The method according to claim 1, comprising determining said one or more N-dimensional color adjustment regions based on a plurality of boundary points and/or criteria based on said spatial representation.

9. The method according to claim 8, comprising retrieving said boundary points and/or data from one or more look-up tables (LUTs) based on image parameters of said pixels.

10. The method according to claim 1, comprising aggregating applicable chroma and/or luma information adjustments where any of said pixels fall in overlapping color adjustment regions.

11. A system for video processing, the system comprising:
one or more circuits for use in a device that processes images, wherein said one or more circuits are operable to determine one or more N-dimensional color adjustment regions within a spatial representation of chroma and luma information corresponding to pixels for an image, where N is an integer that is greater than 1; and
for said one or more determined N-dimensional color adjustment regions, said one or more circuits are operable to adjust said chroma and/or luma information for said pixels utilizing a plurality of one-dimensional (1-D) piece-wise linear (PWL) functions.

12. The system according to claim 11, wherein said chroma and/or luma information is based on Y′CbCr and/or Y/saturation/hue color space.

13. The system according to claim 12, wherein said luma and chroma information comprise Y, Cb, Cr, Hue, and/or Saturation parameters of said pixels.

14. The system according to claim 11, wherein each of said plurality of 1-D PWL functions is utilized to adjust only one of chroma or luma parameters corresponding to said pixels.

15. The system according to claim 14, wherein each of said plurality of 1-D PWL functions is utilized to generate gain or offset adjustment data based on said chroma and/or luma information.

16. The system according to claim 14, wherein at least some of said plurality of 1-D PWL functions is reprogrammable.

17. The system according to claim 14, wherein said plurality of 1-D PWL functions is utilized to enable smooth transitions at boundary areas of at least some of said color adjustment regions.

18. The system according to claim 11, wherein said one or more circuits are operable to determine said one or more N-dimensional color adjustment regions based on a plurality of boundary points and/or criteria based on said spatial representation.

19. The system according to claim 18, wherein said one or more circuits are operable to retrieve said boundary points and/or data from one or more look-up tables (LUTs) based on image parameters of said pixels.

20. The system according to claim 11, wherein said one or more circuits are operable to aggregate applicable chroma and/or luma information adjustments where any of said pixels fall in overlapping color adjustment regions.
